(19) United States
(12) Patent Application Publication
(10) Pub. No.: US 2024/0107287 A1
(43) Pub. Date: Mar. 28, 2024

(54) SUPPORT OF NON-SUBSCRIBED TEMPORARY LOCAL SLICES WHILE ROAMING FOR LOCAL IMS SERVICE

(71) Applicant: Telefonaktiebolaget LM Ericsson (publ), Stockholm (SE)

(72) Inventors: Ankur Dauneria, New Delhi (IN); George Foti, Dollard des Ormeaux (CA)

(21) Appl. No.: 18/038,461

(22) PCT Filed: Nov. 24, 2021
(86) PCT No.: PCT/IB2021/060942

§ 371 Date: May 24, 2023

Related U.S. Application Data
(60) Provisional application No. 63/117,639, filed on Nov. 24, 2020.

(51) Int. Cl. H04W 8/06

(52) U.S. Cl. CPC H04W 8/06; H04W 80/10

(57) ABSTRACT

In one embodiment, a method performed by a wireless communication device comprises sending a registration request to a network node in a visited network and receiving a registration response comprising: (a) information that indicates one or more network slices in the visited network that can be used by the wireless communication device and (b) a link that can be activated by the wireless communication device to obtain a client that treats the wireless communication device as a SNPN client to enable the wireless communication device to make and/or receive calls to/from local wireless communication devices in the visited network. The method further comprises establishing a session with the visited network using one of the one or more network slices indicated by the information comprised in the registration response, activating the link using the session with the visited network, and, responsive thereto, downloading the client and executing the client.

### RELATED APPLICATIONS

This application claims the benefit of provisional patent application Ser. No. 63/117,639, filed Nov. 24, 2020, the disclosure of which is hereby incorporated herein by reference in its entirety.

### TECHNICAL FIELD

The present disclosure relates to providing local access to roaming a wireless communication device in a visited network using a temporary local network slice in a manner that enables the wireless communication device to make and/or receive calls in the visited network using a local number in the visited network, e.g., while maintaining its home number.

### BACKGROUND

Today, Fifth Generation (5G)/Fourth Generation (4G) users who travel abroad for an extended period of time communicate with users back at home using Over the Top (OTT) applications such as Viber or WhatsApp to avoid long distance charges. These users today also buy a local Subscriber Identity Module (SIM) card to be able to initiate and make calls with other users in the area they are visiting. Hence, these users cannot be reached using their home numbers, unless they have two phones, or a phone that can take dual SIMs, and most users do not have either. Most users have only one phone with only one SIM card, and hence they must remove their home SIM card to acquire a local number using a local SIM card. This makes it impossible for anyone to reach them using their well-known home phone numbers. Hence, they can miss business related calls, and they are effectively shut off for reachability using their home phone numbers.

### SUMMARY

Systems and methods are disclosed for enabling a wireless communication device to make and/or receive calls to/from local wireless communication devices in a visited network. In one embodiment, a method comprises, at a wireless communication device, sending a registration request to a network node in a visited network. The method further comprises, at the network node in the visited network, receiving the registration request from the wireless communication device, determining that the wireless communication device is a roaming wireless communication device based on information comprised in the registration request, and responsive thereto sending a registration response to the wireless communication device in response to the registration request. The registration response comprises: (a) information that indicates one or more network slices in the visited network that can be used by the wireless communication device and (b) a link that can be activated by the wireless communication device to obtain a client that treats the wireless communication device as a Stand-Alone Non-Public Network (SNPN) client to enable the wireless communication device to make and/or receive calls to/from local wireless communication devices in the visited network. The method further comprises, at the wireless communication device, receiving the registration response from the network node, establishing a session with the visited network using one of the one or more network slices indicated by the information comprised in the registration response, activating the link using the session with the visited network, and, responsive to activating the link, sending, to an Application Service (AS) associated with the visited network a request to download the client that enables the wireless communication device to make and/or receive calls to/from local wireless communication devices in the visited network. The method further comprises, at the AS associated with the visited network, receiving the request to download the client from the wireless communication device and providing the client to the wireless communication device. The method further comprises, at the wireless communication device, receiving the client from the AS and executing the client at the wireless communication device. In this manner, a roaming wireless communication device is enabled to continue to be reached using the user's home number while also being able to acquire and use a local number in the visited network without needing any changes to the Subscriber Identity Module (SIM).

Embodiments of a method performed by a wireless communication device are also disclosed. In one embodiment, a method performed by a wireless communication device comprises sending a registration request to a network node in a visited network and receiving a registration response in response to the registration request, where the registration response comprises: (a) information that indicates one or more network slices in the visited network that can be used by the wireless communication device and (b) a link that can be activated by the wireless communication device to obtain a client that treats the wireless communication device as a SNPN client to enable the wireless communication device to make and/or receive calls to/from local wireless communication devices in the visited network. The method further comprises establishing a session with the visited network using one of the one or more network slices indicated by the information comprised in the registration response, activating the link using the session with the visited network, and, responsive to activating the link, downloading the client that enables the wireless communication device to make and/or receive calls to/from local wireless communication devices in the visited network and executing the client at the wireless communication device.

In one embodiment, the method further comprises, as a result of executing the client, establishing an Internet Protocol (IP) Multimedia Subsystem (IMS) Protocol Data Unity (PDU) session with an IMS of the visited network acting as an SNPN client. In one embodiment, establishing the IMS PDU session with the IMS of the visited network acting as the SNPN client comprises obtaining an identity to be used by the wireless communication device for making and/or receiving calls to/from local wireless communication devices in the visited network.

In another embodiment, establishing the IMS PDU session with the IMS of the visited network acting as the SNPN client comprises sending an IMS registration request to an IMS node in the IMS of the visited network, the IMS registration request comprising an NPN identity associated to the wireless communication device and receiving an IMS registration response comprising an IMS identity associated to the NPN identity, the IMS identity being an identity to be used by the wireless communication device for making and/or receiving calls to/from local wireless communication devices in the visited network. In one embodiment, the IMS identity associated to the NPN identity of the wireless communication device is at least one of a Tel-uniform resource indicator (Tel-URI) and a Session Initiation Protocol (SIP) Uniform Resource Indicator (URI) comprising a telephone number or the IMS identity associated to the NPN is an IMS Public User Identity (IMPU). In one embodiment, the IMS identity associated to the NPN identity of the wireless communication device is one of an allocated IMS identity and a manually configured IMS identity or the IMS identity associated to the NPN identity of the wireless communication device is a free individual identity allocated from a wildcarded identity of a defined or configured NPN domain. In one embodiment, the NPN identity of the wireless communication device is a SIP URI.

In one embodiment, activating the link comprising activating the link autonomously.

In another embodiment, activating the link comprising activating the link responsive to input received via a user input component of the wireless communication device. In one embodiment, the method further comprises displaying at least some of the information about the one or more network slices and/or the link via a display component of the wireless communication device.

Corresponding embodiments of a wireless communication device are also disclosed. In one embodiment, a wireless communication device is adapted to send a registration request to a network node in a visited network and receive a registration response in response to the registration request, where the registration response comprises: (a) information that indicates one or more network slices in the visited network that can be used by the wireless communication device and (b) a link that can be activated by the wireless communication device to obtain a client that treats the wireless communication device as a SNPN client to enable the wireless communication device to make and/or receive calls to/from local wireless communication devices in the visited network. The wireless communication device is further adapted to establish a session with the visited network using one of the one or more network slices indicated by the information comprised in the registration response, activate the link using the session with the visited network, and, responsive to activating the link, download the client that enables the wireless communication device to make and/or receive calls to/from local wireless communication devices in the visited network and execute the client at the wireless communication device.

Embodiments of a method performed by a network node in a visited network of a wireless communication device are also disclosed. In one embodiment, a method performed by a network node is a visited network of a wireless communication device comprises receiving a registration request from the wireless communication device and determining that the wireless communication device is a roaming wireless communication device based on information comprised in the registration request. The method further comprises, responsive to determining that the wireless communication device is a roaming wireless communication device, sending a registration response to the wireless communication device in response to the registration request, the registration response comprising: (a) information that indicates one or more network slices in the visited network that can be used by the wireless communication device and (b) a link that can be activated by the wireless communication device to obtain a client that treats the wireless communication device as a stand-alone non-public network, SNPN, client to enable the wireless communication device to make and/or receive calls to/from local wireless communication devices in the visited network.

In one embodiment, the client enables the wireless communication device to establish an IMS PDU session with an IMS of the visited network acting as an SNPN client.

In one embodiment, the client enables the wireless communication device to obtain an identity to be used by the wireless communication device for making and/or receiving calls to/from local wireless communication devices in the visited network. In one embodiment, the identity is an IMS identity associated to an NPN identity of the wireless communication device. In one embodiment, the IMS identity associated to the NPN identity of the wireless communication device is at least one of a Tel-URI and a SIP URI comprising a telephone number or the IMS identity associated to the NPN identity of the wireless communication device is an IMS Public User Identity, IMPU. In one embodiment, the IMS identity associated to the NPN is one of an allocated IMS identity and a manually configured IMS identity or the IMS identity associated to the NPN is a free individual identity allocated from a wildcarded identity of a defined or configured NPN domain.

In one embodiment, the visited network is a Visited Public Land Mobile Network (VPLMN) comprising a Fifth Generation Core (5GC) and the network node is an Access and Mobility Management Function (AMF) in the 5GC of the VPLMN.

Corresponding embodiments of a network node in a visited network of a wireless communication device are also disclosed. In one embodiment, a network node in a visited network of a wireless communication device is adapted to receive a registration request from the wireless communication device and determine that the wireless communication device is a roaming wireless communication device based on information comprised in the registration request. The network node is further adapted to, responsive to determining that the wireless communication device is a roaming wireless communication device, send a registration response to the wireless communication device in response to the registration request, the registration response comprising: (a) information that indicates one or more network slices in the visited network that can be used by the wireless communication device and (b) a link that can be activated by the wireless communication device to obtain a client that treats the wireless communication device as a stand-alone non-public network, SNPN, client to enable the wireless communication device to make and/or receive calls to/from local wireless communication devices in the visited network.

Embodiments of a method performed by an AS associated with a visited network of a wireless communication device are also disclosed. In one embodiment, method performed by an AS associated with a visited network of a wireless communication device comprises receiving a request from the wireless communication device and providing a client to the wireless communication device, the client configured to treat the wireless communication device as a SNPN client to enable the wireless communication device to make and/or receive calls to/from local wireless communication devices in the visited network.

Corresponding embodiments of a network node that implements an AS associated with a visited network of a wireless communication device are also disclosed. In one embodiment, a network node that implements an AS associated with a visited network of a wireless communication device is adapted to receive a request from the wireless communication device and providing a client to the wireless communication device, the client configured to treat the wireless communication device as a SNPN client to enable the wireless communication device to make and/or receive calls to/from local wireless communication devices in the visited network.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIGS. 2 and 3 illustrate example embodiments in which the cellular communications system of FIG. 1 is a Fifth Generation System (5GS);

FIG. 4A illustrates the operation of a wireless communication device and various network nodes in accordance with one embodiment of the present disclosure;

FIG. 4B is a flow chart that illustrates a process by which, by acting as a Stand-alone Non-Public Network (SNPN) client, the User Equipment (UE) of FIG. 4A obtains a local number for making and/or receiving calls in the visited network, in accordance with one embodiment of the present disclosure;

FIGS. 5, 6, and 7 illustrate example embodiments of a network node in which aspects of the present disclosure may be implemented; and

FIGS. 8 and 9 illustrate example embodiments of a wireless communication device (e.g., a UE) in which aspects of the present disclosure may be implemented.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell;” however, particularly with respect to 5G NR concepts, beams may be used instead of cells and, as such, it is important to note that the concepts described herein are equally applicable to both cells and beams.

There currently exist certain challenge(s). Today, Fifth Generation (5G)/Fourth Generation (4G) users who travel abroad for an extended period of time communicate with users back at home using Over the Top (OTT) applications such as Viber or WhatsApp to avoid long distance charges. These users today also buy a local Subscriber Identity Module (SIM) card to be able to initiate and make calls with other users in the area they are visiting. Hence, these users cannot be reached using their home numbers, unless they have two phones, or a phone that can take dual SIMs, and most users do not have either. Most users have only one phone with only one SIM card, and hence they must remove their home SIM card to acquire a local number using a local SIM card. This makes it impossible for anyone to reach them using their well-known home phone numbers. Hence, they can miss business related calls, and they are effectively shut off for reachability using their home phone numbers.

One use case for network slicing in a cellular communications system such as, e.g., a Third Generation Partnership Project (3GPP) Evolved Packet System (EPS) or Fifth Generation System (5GS) is assigning local slices in a visiting domain for a temporary purpose(s) (e.g., location/time-based access). As described below in detail, such local slices in a visiting domain are utilized to address, e.g., the problem described above.

Certain aspects of the present disclosure and their embodiments may provide solutions to the aforementioned or other challenges. Using embodiments of the solution(s) disclosed herein, roaming users are able to continue to use their home SIM cards in their User Equipments (UEs), communicate with users back at home using OTT applications such as Viber on their UEs, and receive incoming calls on their UEs using their home numbers, business related or otherwise. However, in this case, with embodiments of the solution(s) described herein, the visited network allows the UEs of these users to also acquire temporary local numbers for local communication and be able to use network slices in the visited domain for local communication—all without changing the home SIM cards of the UEs. This provides a huge advantage for users, in terms of convenience, and operators, for additional revenues from inbound roamers.

Embodiments of the solution disclosed herein treat inbound roamers like UEs of Stand-Alone Non-Public Networks (SNPNs). SNPNs are also referred to herein as stand-alone private networks. Today, SNPN UEs acquire Internet Protocol (IP) Multimedia Subsystem (IMS) services through one of several options. One of these options is using a wild carded identity allocated to a SNPN UE by the IMS domain. In this option, a SNPN UE can acquire a local number via an IMS registration using its Subscription Permanent Identifier (SUPI) for that purpose. The SNPN UE can use this number to make or receive calls. The SNPN UE in this case does not need to change its SIM card or do anything special.

Applying the same principles to inbound roamers in this use case, an inbound roaming UE discovers one or more network slices in the visited domain that it can use, e.g., for a temporary purpose (e.g., for temporary voice service). The inbound roaming UE is then provided with a downloadable client that it uses to allow it to register in an IMS domain of the visited network to receive a local number in the visited network. The inbound roaming UE then use this number, e.g., to make or receive calls locally. In one embodiment, the IMS domain used for this is one in the visited domain accessed using a local slice discovered by the inbounding roaming UE at Fifth Generation Core (5GC) registration. The inbound roaming UE can also use its home IMS simultaneously with the local IMS domain in the visited network. Hence, the UE can establish an IMS PDU session with their home IMS network using a respective embedded client (as is the case today) and it can also establish an IMS PDU session with the visited IMS domain (i.e., the IMS domain in the visited network) using the downloaded client and the visited network slice(s) that it discovered (e.g., at 5GC registration) with the visited network. The UE uses the IMS domain in the visited domain to acquire the local number.

The call flows are provided herein that show details of example embodiments of the solution described herein.

Certain embodiments may provide one or more of the following technical advantage(s). Millions of roaming UEs of users travelling each day across the world provide an important potential for a revenue boost for operators with embodiments of the solution described herein. For these roaming UEs, the ability to continue to be reached using the user home number while also being able to acquire and use a local number in the visited domain without needing any changes to the SIM is a tremendous advantage and provides mutual benefits to both users and network operators.

In one embodiment, this service is supported by the service provider on its own to increase its revenue.

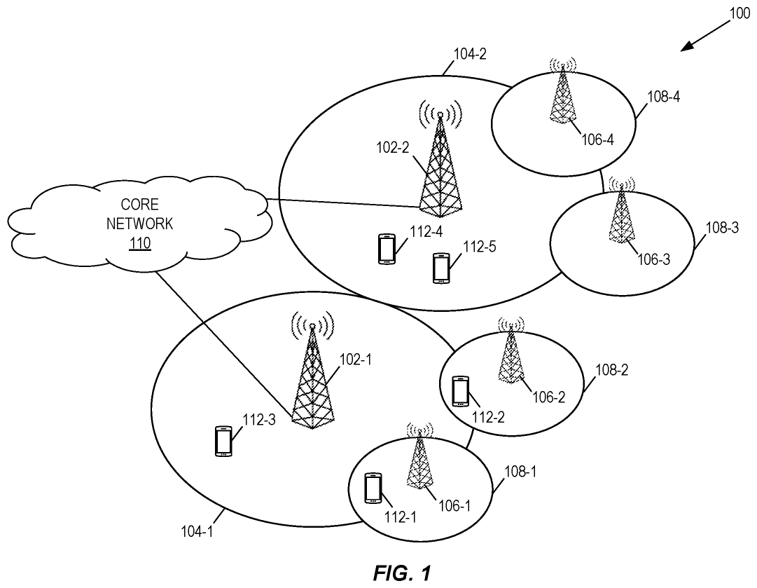

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC); however, the present disclosure is not limited thereto. In this example, the RAN includes base stations 102-1 and 102-2, which in the 5GS include NR base stations (gNBs) and optionally next generation eNBs (ng-eNBs), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs and as such also referred to herein as UEs 112, but the present disclosure is not limited thereto.

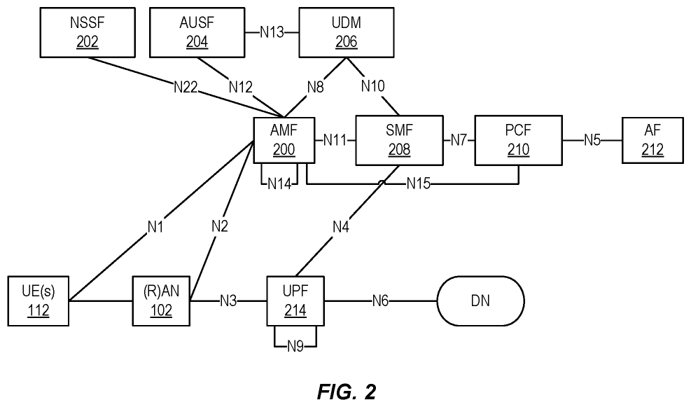

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of UEs 112 connected to either a RAN 102 or an Access Network (AN) as well as an AMF 200. Typically, the R(AN) 102 comprises base stations, e.g. such as eNBs or gNBs or similar. Seen from the core network side, the 5GC NFs shown in FIG. 2 include a NSSF 202, an AUSF 204, a UDM 206, the AMF 200, a SMF 208, a PCF 210, and an Application Function (AF) 212.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating UP and CP. The UP carries user traffic while the CP carries signaling in the network. In FIG. 2, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

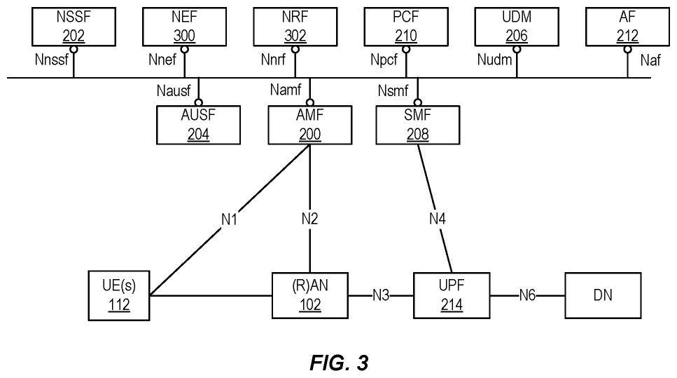

FIG. 3 illustrates a 5G network architecture using service-based interfaces between the NFs in the CP, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF 200 and Nsmf for the service based interface of the SMF 208, etc. The NEF 300 and the NRF 302 in FIG. 3 are not shown in FIG. 2 discussed above. However, it should be clarified that all NFs depicted in FIG. 2 can interact with the NEF 300 and the NRF 302 of FIG. 3 as necessary, though not explicitly indicated in FIG. 2.

Some properties of the NFs shown in FIGS. 2 and 3 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

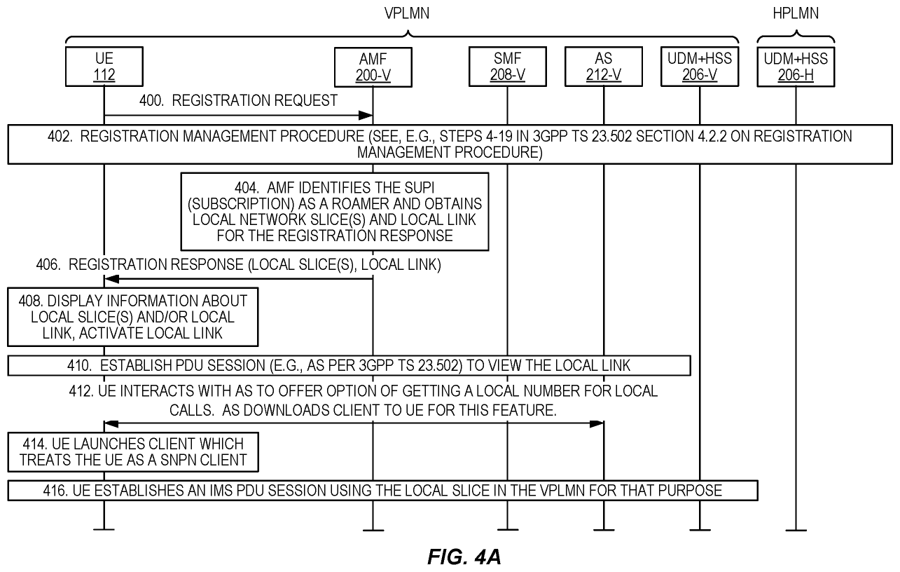

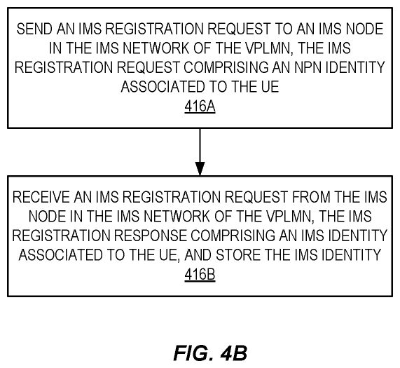

FIG. 4A is a diagram that illustrates a procedure in accordance with one embodiment of the present disclosure. In this procedure, the UE 112 is in a Visited Public Land Mobile Network (VPLMN). In other words, the UE 112 is a “roaming UE” or “inbound roaming UE”. Note that nodes of the VPLMN are differentiated from nodes in a Home Public Land Mobile Network (HPLMN) of the UE 112 in FIG. 4A by appending “-V” to the reference number for the node when referring to a node in the VPLMN and appending a “-H” to the reference number of the node when referring to a node in the HPLMN. The following is a brief description of the procedure illustrated in FIG. 4A.

Step 400: In step 400, the UE 100 issues a 5GC Registration Request to the AMF 200-V in the VPLMN. The 5GC Registration Request may be sent as described in 3GPP TS 23.502 (see, e.g., V16.6.0).

Step 402: In step 402, the UE 112 and the network nodes of the VPLMN perform operations of the registration procedure. More specifically, in one embodiment, the UE 112 and the network nodes of the VPLMN perform steps 4-19 of section 4.2.2 in 3GPP TS 23.502.

Step 404: In step 404, the AMF 200-V identifies the SUPI of the UE 112 (i.e., the registering SUPI), from the domain name, as a roamer. In other words, the AMF 200-V identifies the UE 112 as a roaming UE. Note that, in one embodiment, the SUPI is a Network Access Identifier (NAI) that takes the form of “user@realm,” where the realm is the domain name. From this domain name, the AMF 200-V can determine that the UE 112 is a roaming UE. Responsive to identifying the UE 112 as a roaming UE, the AMF 200-V obtains information about one or more local slices (i.e., one or more network slices of the VPLMN such as, e.g., one or more network slices in the core network of the VPLMN) that are configured in the AMF 200-V for use by inbound roaming UEs to the UE 112 and a local link to be included in the Registration Response message (i.e., the Registration Accept message). In one embodiment, the information about the one or more local slices comprises information that enables the UE 112 to establish a PDU session with the local slice(s). For example, the information about the one or more local slices provided as or as part of a list of allowed S-NSSAIs. For instance, this list of allowed S-NSSAIs may include S-NSSAIs of the one or more local slices configured for use by inbound roaming UEs and, in some embodiments, one or more additional S-NSSAIs, e.g., for use in the conventional manner. Note that, in one embodiment, in order to define the one or more local slices configured for use locally in the VPLMN, the S-NSSAI information comprised in the list is extended to indicate that these slices are used for local purpose and, optionally, to include the local link to be used by the UE 112 to download a client application as described below. In one embodiment, the AMF 200-V in the VPLMN is configured with a white list for the domains that should receive this information in a Registration Accept and provides this information upon determining that the domain name of the SUPI of the UE 112 is in the white list.

Step 406: In step 406, the AMF 200-V sends a Registration Response to the UE 112, where the Registration Response includes the information about local slices to be used as well as the local link that the UE 112 is to use to download a client application to be used to obtain a local number in the VPLMN. As discussed above, in one embodiment, this information and the local link are included in a list of allowed S-NSSAIs. In this embodiment, the local link is a pointer to a local AS, which is denoted in FIG. 4A as AS 212-V. Note that some aspects of the Registration procedure are skipped for brevity. While needed for understanding of the solution, for additional details, the interested reader is directed to 3GPP TS 23.502.

Step 408: In step 408, the UE 108 displays the information about the local slice(s) and/or the local link to the user. The UE 112 activates the local link, e.g., responsive to input from the user.

Step 410: In step 410, by activating the local link, the UE 112 establishes a PDU session to the AS 212-V associated with the local link. Note that activation of the local link may be triggered by the user manually or autonomously by the UE 112, which recognizes the local link. In either case, a PDU session is established via the internet DDN towards the AS associated with the link

Step 412: In step 412, the UE 112 interacts with the AS 212-V to indicate that it desires to use the provided service (i.e., indicates that it desires to obtain a local number in the PLMN for temporary service). Responsive thereto, the AS 212-V downloads a client to the UE 112. The client enables the UE 112 to act as a SNPN client to obtain and use a local number in the VPLMN. In one embodiment, the downloaded client only supports originating calls to local UEs in the VPLMN and/or receiving calls from local UEs in the VPLMN. Note that the interactions with the AS 2120V are similar to the interactions with the RLOS use case depicted in U.S. Pat. No. 11,122,417 B2, entitled SUPPORT FOR MANUAL ROAMING FOR VOLTE, which was issued Sep. 14, 2021.

Step 414: In step 414, the UE 112 launches the client. The client treats the UE 112 as a SNPN client. In other words, the client causes the UE 112 to act as a SNPN client, where the SUPI corresponds to the SNPN identity. By behaving as a SNPN client, the UE 112 can acquire a local number in the VPLMN. Note that acquiring a local number is optional and can be offered by the IMS provider in the VPLMN.

Step 416: In step 416, upon launching the client, the client causes the UE 112 to establish an IMS PDU session with the visited IMS system using the local slice. If more than one local slice was indicated in the Registration Response, the local slice to be used is selected from the indicated local slices in any desired manner. In one embodiment, establishing the IMS PDU session includes obtaining an identity (e.g., phone number) that is to be used by the UE 112 when making and/or receiving calls in the VPLMN.

In order to receive calls and originate calls locally in the VPLMN, the client causes the UE 112 to, acting as a SNPN client, acquire a local number (e.g., a local IMPU). Acquiring a local number is an option and can be offered by the IMS provider in the visited domain. More specifically, as illustrated in FIG. 4B, in one embodiment, the UE 112, acting as an SNPN client, sends an IMS registration request to a P-CSCF in the local IMS domain of the VPLMN, where the IMS registration request includes an NPN identifier associated to the UE 112 (e.g., via the downloaded client) (step 416A). Note that the terms “identifier” and “identity” (e.g., in regarding to the NPN identifier and IMS identifier of the UE 112) are used interchangeable herein. The NPN identifier in this case corresponds to the UE SUPI. Responsive to the IMS registration request, the UE 112 receives and stores an IMS identifier associated to the UE 112 acting as an SNPN client (step 416B). In one embodiment, the IMS identifier is a Tel-uniform resource indicator (Tel-URI) and/or the NPN identifier of the UE 112 is a SIP URI. In some embodiments, the IMS identifier is a SIP URI comprising a telephone number. In some embodiments, the IMS identifier is one of an allocated IMS identifier and a manually configured IMS identifier. In some embodiments, the IMS identifier is an IMS Public User Identity (IMPU). In some embodiments, the allocated IMS identifier is a free individual identity allocated from a wildcarded identity of the NPN domain. The UE 112 may then receive calls and original calls locally in the VPLMN using the IMS identifier.

If the UE 112 does not acquire a local number, then in one embodiment the UE's original home MSISDN is used as caller ID. Otherwise, the acquired local number is used as caller ID when the UE 112 originates local calls.

It is important to note that behavior of the local IMS domain for handling local calls is described in U.S. Pat. No. 11,122,417 B2. Although Pat. No. 11,122,417 B2 focuses on supporting originating calls, the handling of terminating calls is like a regular terminating IMS call.

Note that, in one embodiment, the UE 112 also establishes an additional and separate IMS PDU session with its home IMS domain for using its home number (e.g., home MSISDN number) to make or receive calls. The UE 112 uses in this case the embedded client in the phone.

It should also be noted that as one alternative to downloading the client to the UE 112 is an embodiment in which the UE 112 has a native IMS client and downloads only credentials from the AS 212-V.

Some non-limiting aspects of the solution described herein at the AMF 200-V and the UE 112 are as follows:
UE: The UE 112 recognizes the additional information in Registration Response message activates the provided local link (e.g., either autonomously or in response to user input). The UE 112 downloads the client from the AS 212-V to use for local services in the VPLMN. Using the downloaded client, the UE 112 makes and/or receives call from local UEs in the VPLMN. The UE 112 provides the associated user interface related information.
AMF: The AMF 200-V is, on one embodiment, configured with a white list of domains for whom the service applies. By examining the SUPI comprised in the Registration Request from the UE 112, the AMF 200-V determines that the domain of the UE 112 is a roaming UE 112. Optionally, based on the domain, the AMF 200-V may also determine that the UE 112 is from a domain for which the service described herein is to be provided. The AMF 200-V then provides information about one or more local slices configured (provisioned) in the AMF 200-V for this service and a local link to the UE 112 in the Registration Response message, as described above. Provide the configured information.

Note that while the UE 112 acts as an NPN Client and can acquire a IMS identifier in the form of, e.g., Tel URI at IMS registration as described above, in another embodiment, the AS 212-V can allocate a free IMS identifier during its interaction with the UE 112. The AS 212-V will acquire the UE SUPI during its interaction with the client. It allocates a free IMS identifier, provisioned in the AS 212-V and binds it to the SUPI in a P-CSCF database via Operations and Management (O&M) means.

The duration of allocation of that IMS identifier to the UE 112 depends on the AS 212-V and the options supported in the AS 212-V, and this duration is decided by the AS 212-V during its interaction with the UE 112, and is it of scope.

In one embodiment, the UE 112 can act as an Restricted Local Operator Services (RLOS) client and be allowed to initiate calls only using its original number, as long as the P-CSCF is configured by the AS for that purpose as described in U.S. Pat. No. 11,122,417 B2.

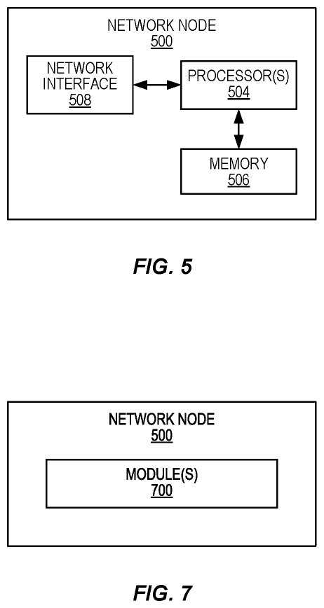

FIG. 5 is a schematic block diagram of a network node 500 according to some embodiments of the present disclosure. Optional features are represented by dashed boxes. The network node 500 may be, for example, a network node that implements the AMF 200-V or the AS 212-V described herein. As illustrated, the network node 500 includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. The one or more processors 504 operate to provide one or more functions of the network node 500 as described herein (e.g., one or more functions of the AMF 200-V or AS 212-V as described herein). In some embodiments, the function(s) are implemented in software that is stored, e.g., in the memory 506 and executed by the one or more processors 504.

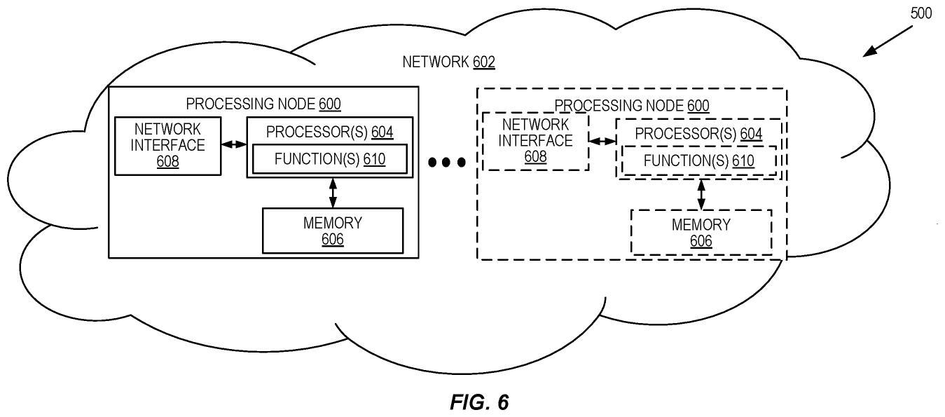

FIG. 6 is a schematic block diagram that illustrates a virtualized embodiment of the network node 500 according to some embodiments of the present disclosure. Again, optional features are represented by dashed boxes. As used herein, a “virtualized” network node is an implementation of the network node 500 in which at least a portion of the functionality of the network node 500 is implemented as a virtual component(s) (e.g., via a virtual machine(s) executing on a physical processing node(s) in a network(s)). As illustrated, in this example, the network node 500 includes one or more processing nodes 600 coupled to or included as part of a network(s) 602. Each processing node 600 includes one or more processors 604 (e.g., CPUs, ASICs, FPGAs, and/or the like), memory 606, and a network interface 608. In this example, functions 610 of the network node 500 described herein are implemented at the one or more processing nodes 600 in any desired manner. In some particular embodiments, some or all of the functions 610 of the network node 500 described herein are implemented as virtual components executed by one or more virtual machines implemented in a virtual environment(s) hosted by the processing node(s) 600.

In some embodiments, a computer program including instructions which, when executed by at least one processor, causes the at least one processor to carry out the functionality of the network node 500 or a node (e.g., a processing node 600) implementing one or more of the functions 610 of the network node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the network node 500 according to some other embodiments of the present disclosure. The network node 500 includes one or more modules 700, each of which is implemented in software. The module(s) 700 provide the functionality of the network node 500 described herein. This discussion is equally applicable to the processing node 600 of FIG. 6 where the modules 700 may be implemented at one of the processing nodes 600 or distributed across multiple processing nodes 600.

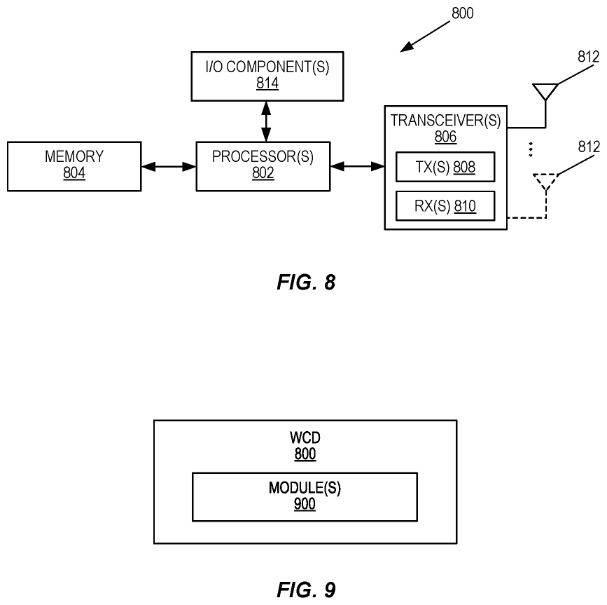

FIG. 8 is a schematic block diagram of a wireless communication device 800 according to some embodiments of the present disclosure. The wireless communication device 800 may be the wireless communication device 112 or UE as described herein. As illustrated, the wireless communication device 800 includes one or more processors 802 (e.g., CPUs, ASICs, FPGAs, and/or the like), memory 804, and one or more transceivers 806 each including one or more transmitters 808 and one or more receivers 810 coupled to one or more antennas 812. The transceiver(s) 806 includes radio-front end circuitry connected to the antenna(s) 812 that is configured to condition signals communicated between the antenna(s) 812 and the processor(s) 802, as will be appreciated by on of ordinary skill in the art. The processors 802 are also referred to herein as processing circuitry. The transceivers 806 are also referred to herein as radio circuitry. In some embodiments, the functionality of the wireless communication device 800 described above (e.g., the functionality of the wireless communication device 112 or UE) may be fully or partially implemented in software that is, e.g., stored in the memory 804 and executed by the processor(s) 802. The wireless communication device 800 may also include one or more input/output components (e.g., an input/output interface including a display, buttons, a touch screen, a microphone, a speaker(s), and/or the like and/or any other components for allowing input of information into the wireless communication device 800 and/or allowing output of information from the wireless communication device 800). Note that the wireless communication device 800 may include additional components not illustrated in FIG. 8 such as, e.g., a power supply (e.g., a battery and associated power circuitry), etc.

In some embodiments, a computer program including instructions which, when executed by at least one processor, causes the at least one processor to carry out the functionality of the wireless communication device 800 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the wireless communication device 800 according to some other embodiments of the present disclosure. The wireless communication device 800 includes one or more modules 900, each of which is implemented in software. The module(s) 900 provide the functionality of the wireless communication device 800 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. (canceled)

2. A method performed by a wireless communication device, the method comprising:
sending a registration request to a network node in a visited network;
receiving a registration response in response to the registration request, the registration response comprising: information that indicates one or more network slices in the visited network that can be used by the wireless communication device and a link that can be activated by the wireless communication device to obtain a client that treats the wireless communication device as a stand-alone non-public network, SNPN, client to enable the wireless communication device to make and/or receive calls to/from local wireless communication devices in the visited network;
establishing a session with the visited network using one of the one or more network slices indicated by the information comprised in the registration response;
activating the link using the session with the visited network;
responsive to activating the link, downloading the client that enables the wireless communication device to make and/or receive calls to/from local wireless communication devices in the visited network; and
executing the client at the wireless communication device.

3. The method of claim 2 wherein the method further comprises, as a result of executing the client, establishing an Internet Protocol, IP, Multimedia Subsystem, IMS, Protocol Data Unity, PDU, session with an IMS of the visited network acting as an SNPN client.

4. The method of claim 3 wherein establishing the IMS PDU session with the IMS of the visited network acting as the SNPN client comprises obtaining an identity to be used by the wireless communication device for making and/or receiving calls to/from local wireless communication devices in the visited network.

5. The method of claim 3 wherein establishing the IMS PDU session with the IMS of the visited network acting as the SNPN client comprises:
sending an IMS registration request to an IMS node in the IMS of the visited network, the IMS registration request comprising an NPN identity associated to the wireless communication device; and
receiving an IMS registration response comprising an IMS identity associated to the NPN identity, the IMS identity being an identity to be used by the wireless communication device for making and/or receiving calls to/from local wireless communication devices in the visited network.

6. The method of claim 5 wherein:
the IMS identity associated to the NPN identity of the wireless communication device is at least one of a Tel-uniform resource indicator, Tel-URI, and a Session Initiation Protocol, SIP, Uniform Resource Indicator, URI, comprising a telephone number; or
the IMS identity associated to the NPN is an IMS Public User Identity, IMPU.

7. The method of claim 5 or 6 wherein:
the IMS identity associated to the NPN identity of the wireless communication device is one of an allocated IMS identity and a manually configured IMS identity; or
the IMS identity associated to the NPN identity of the wireless communication device is a free individual identity allocated from a wildcarded identity of a defined or configured NPN domain.

8. The method of claim 5 wherein the NPN identity of the wireless communication device is a Session Initiation Protocol, SIP, Uniform Resource Indicator, URI.

9. The method of claim 2 wherein activating the link comprising activating the link autonomously.

10. The method of claim 2 wherein activating the link comprising activating the link responsive to input received via a user input component of the wireless communication device.

11. The method of claim 10 further comprising displaying at least some of the information about the one or more network slices and/or the link via a display component of the wireless communication device.

12. A wireless communication device adapted to:
send a registration request to a network node in a visited network;
receive a registration response in response to the registration request, the registration response comprising: information that indicates one or more network slices in the visited network that can be used by the wireless communication device and a link that can be activated by the wireless communication device to obtain a client that treats the wireless communication device as a stand-alone non-public network, SNPN, client to enable the wireless communication device to make and/or receive calls to/from local wireless communication devices in the visited network;
establish a session with the visited network using one of the one or more network slices indicated by the information comprised in the registration response;
activate the link using the session with the visited network;
responsive to activating the link, download the client that enables the wireless communication device to make and/or receive calls to/from local wireless communication devices in the visited network; and
execute the client at the wireless communication device.

13. (canceled)

14. A method performed by a network node in a visited network of a wireless communication device, the method comprising:
receiving a registration request from the wireless communication device;
determining that the wireless communication device is a roaming wireless communication device based on information comprised in the registration request; and
responsive to determining that the wireless communication device is a roaming wireless communication device, sending a registration response to the wireless communication device in response to the registration request, the registration response comprising: information that indicates one or more network slices in the visited network that can be used by the wireless communication device and a link that can be activated by the wireless communication device to obtain a client that treats the wireless communication device as a stand-alone non-public network, SNPN, client to enable the wireless communication device to make and/or receive calls to/from local wireless communication devices in the visited network.

15. The method of claim 14 wherein the client enables the wireless communication device to establish an Internet Protocol, IP, Multimedia Subsystem, IMS, Protocol Data Unit, PDU, session with an IMS of the visited network acting as an SNPN client.

16. The method of claim 14 wherein the client enables the wireless communication device to obtain an identity to be used by the wireless communication device for making and/or receiving calls to/from local wireless communication devices in the visited network.

17. The method of claim 16 wherein the identity is an IMS identity associated to an NPN identity of the wireless communication device.

18. The method of claim 17 wherein:
the IMS identity associated to the NPN identity of the wireless communication device is at least one of a Tel-uniform resource indicator, Tel-URI, and a Session Initiation Protocol, SIP, Uniform Resource Indicator, URI, comprising a telephone number; or
the IMS identity associated to the NPN identity of the wireless communication device is an IMS Public User Identity, IMPU.

19. The method of claim 17 wherein:
the IMS identity associated to the NPN is one of an allocated IMS identity and a manually configured IMS identity; or
the IMS identity associated to the NPN is a free individual identity allocated from a wildcarded identity of a defined or configured NPN domain.

20. The method of claim 14 wherein the visited network is a Visited Public Land Mobile Network, VPLMN, comprising a Fifth Generation Core, 5GC, and the network node is an Access and Mobility Management Function, AMF, in the 5GC of the VPLMN.

21. A network node in a visited network of a wireless communication device, the network node adapted to:
receive a registration request from the wireless communication device;
determine that the wireless communication device is a roaming wireless communication device based on information comprised in the registration request; and
responsive to determining that the wireless communication device is a roaming wireless communication device, send a registration response to the wireless communication device in response to the registration request, the registration response comprising: information that indicates one or more network slices in the visited network that can be used by the wireless communication device and a link that can be activated by the wireless communication device to obtain a client that treats the wireless communication device as a stand-alone non-public network, SNPN, client to enable the wireless communication device to make and/or receive calls to/from local wireless communication devices in the visited network.

22. (canceled)
